(19) United States
(12) Patent Application Publication
(10) Pub. No.: US 2016/0346168 A1
(43) Pub. Date: Dec. 1, 2016

(54) NURSING BOTTLE HAVING AIR RETURNING FUNCTION

(71) Applicant: Qingyang SUN, Guangzhou (CN)

(72) Inventor: Qingyang SUN, Guangzhou (CN)

(21) Appl. No.: 14/916,185

(22) PCT Filed: Jun. 10, 2014
(86) PCT No.: PCT/CN2014/079556

§ 371 Date: Mar. 3, 2016

(30) Foreign Application Priority Data
May 24, 2013 (CN) 201310200133.9

(51) Int. Cl. A61J 11/02; A61J 11/04; A61J 9/04

(52) U.S. Cl. CPC A61J 11/02; A61J 9/04; A61J 11/04

(57) ABSTRACT

A nursing bottle having an air returning function comprises a bottle body, a fixing cover, a nipple, a ventilation component, an air conduit, an elastic one-way valve set at a second opening of the air conduit and is located at the interior of the air conduit, a mounting pan located on the second opening of the air conduit to secure the elastic one-way valve. The ventilation component, the air conduit, the elastic one-way valve and the mounting part forms a gas returning device and are located on the interior of the bottle. The present invention reduces the contacting area between the air and the milk, lowering the amount of loss of vitamin. The phenomenon of vomiting milk, choking and flatulence will be omitted since no air bubble is generated.

### FIELD OF THE INVENTION

The present invention relates to the field of nursing bottles. More particularly, this invention relates to nursing bottles having an air returning function.

### BACKGROUND OF THE INVENTION

The nursing bottles in the current market for feeding the babies generally have the following problems:

traditional nursing bottle is composed of bottle body cap and elastic nipples. Except for the hole set on the elastic nipple, the other parts of the bottle are tightly sealed. When the baby sucks the milk, the volume of the liquid inside the bottle decreases and the air volume inside the bottle increases. A negative pressure is thus generated. The generated negative pressure increases a resistant force for the liquid flowing from the elastic nipple. The baby has to suck quite strenuously under this circumstance. When a larger negative pressure is formed inside the bottle, the outside air is being pushed into the bottle, which can easily generate a large number of bubbles in the bottle. After inhaling the milk containing, gas bubble, the gas accumulates inside the baby's abdomen, the baby may vomit milk, and too much air in the stomach and digestive tract causes abdominal pain.

Generally, the vitamin C contained in milk has strong reducibility, It can be extremely easy to be oxidated and lost. While vitamin A has oxidability, when the content of vitamin C is reduced to a certain degree, vitamin A and vitamin F will start to be lost. When an outside air enters into the traditional bottle through holes of the elastic nipples, the contacting time between the outside air and the milk is long, which results in a significant decrease in vitamins A and E, or a complete loss of vitamin C.

In order to solve the above problems, in the market there are also some bottles featured in preventing the phenomenon of flatulence. Those bottles are all set with an inner cap inside the bottle cap which compresses the nipple. There are several inlet holes on the inner cap. Air is transported into the bottom of the bottle through a weasand. Air passes through the inlet hole and goes directly into the bottom of the bottle when the baby sucks the milk with the nursing bottle having above structure. There'll be no air bubbles inside the milk, which prevents the flatulence from happening. However, due to the existence of the inlet holes, the milk will continue to drop into the baby's mouth even when the baby is not sucking the nipple (this is due to the generated positive pressure when feeding). The milk fills the baby's mouth, in this case, milk may flow out of the baby's mouth or the baby may vomit the milk, which wets baby's clothes. More seriously, the milk naturally flows into the baby's esophagus and the trachea, which causes the phenomenon of choking on milk. Besides, the internal pressure is same with exterior pressure, the milk flows into the baby's mouth without sucking. This does harm to the training of baby's sucking ability.

Besides, the air guiding device of the existing nursing bottle is complicated. There are many tiny accessories. The bottles must be cleaned and disinfected immediately after using, the cleaning time for the multiple parts is too long and it is quite inconvenient.

### BRIEF DESCRIPTION OF THE INVENTION

The present invention is to provide a nursing bottle having an air returning function, which does not generate air bubbles in the milk, thus decreasing the phenomenon of vomiting milk, chocking and flatulence. The manufacturing process is relatively simple, which is easy for the mass production. The simple structure is also easy to clean.

In order to achieve the above goals, the present invention provides the following solution: a nursing, bottle having an air returning function, which comprises: a bottle body, a fixing cover, a nipple, wherein one end of the bottle body opens and the other end of the bottle body closes, the fixing cover is used to secure the bottle body and the nipple. The nursing bottle further comprises a ventilation component, which is configured to exchange air between an inner ambiance of the bottle body and an exterior circumstance, an air conduit, wherein the air conduit is a gas operated device with two ends open, and the first opening of the air conduit is connected to the ventilation component: an elastic one-way valve set at a second opening of the air conduit and located in the interior of the air conduit, wherein the elastic one-way valve has at least one cut thereon: a mounting part is located on the second opening of the air conduit to secure the elastic one-way valve. The ventilation component, the air conduit, the elastic one-way valve and the mounting part forms a gas returning device and are located on the interior of the bottle.

Furthermore, a back-up ring is located at the second opening of the air conduit. The back-up ring is used for the installation of the elastic one-way valve. The back-up ring and the air conduit are an integrated structure.

Furthermore, a plurality of corresponding edges of the back-up ring is located at the edges of the elastic one-way valve; wherein when the elastic one-way valve is connected with the air conduit, the plurality of corresponding edges are connected with the back-up ring.

Furthermore, the mounting part is installed on the plurality of corresponding edges to keep a nature status of the elastic one-way-valve; the mounting part is firmly connected to the air conduit,

Furthermore, the ventilation component is a helm-like wheel. The helm-like wheel is located at an opening of the bottle body. An air passage and a milk channel are located at the helm-like wheel. The air passage is connected to the first opening of the air conduit. The air in the inner ambiance orderly passes through the elastic one-way valve, the air conduit and the air passage to exchange air with the exterior of the bottle body. The milk in the inner ambiance flows into the nipple through the milk channel.

Furthermore, the air passage has an interference fit with the first opening of the air conduit.

Furthermore, the milk channel is a through-hole. The milk in the bottle body flows into the nipple through the through-hole.

Furthermore, the milk channel is a hole with a one-way valve, which is in an open position when the nipple is being sucked under an external force. The one-way valve is in a closed position when the nipple is in the natural status.

Furthermore, the diameter of the helm-like wheel is no less than the diameter of the opening of the bottle body.

Furthermore, the ventilation component is a gas import hole, which is located on a side wall of the nipple A supporting component is connected to the gas import hole. Supporting component is used to support and connect the first opening of the gas import hole. Inner air is exchanged with the exterior air in a sequence through the elastic one-way valve, the air conduit, the supporting component and the gas import hole.

Furthermore, the supporting component has an interference fit with the first opening of the air conduit.

Furthermore, a projection located in the middle of the nipple mouth is set with a milk hole.

Furthermore, the projection located in the middle of the nipple mouth comprises a nipple incision

The present invention reduces the contacting area between the air and the milk, lowering the loss of vitamin. The baby would not vomit milk due to sucking into air. The flowing resistance of the milk is reduced. The baby can suck milk without using too much strength. When the baby is not sucking, the milk inside the milk bottle is being prevented from flowing out (decreasing the positive force to the lowest, when feeding). The milk flows out of the bottle only if the baby sucks the milk. The phenomenon of spitting, choking and flatulence will be omitted, since no air bubble is generated. The accessories for the bottle are greatly reduced, which brings in convenience for the daily use, cleaning, sterilizing and carrying. The risk for the baby's swallowing, of small accessories is reduced. The manufacturing process is relatively simple, the mass production is thus achieved. The air returning assembly of the present invention can be used in nursing bottle but not limited thereto. It can also be used in other drinking containers which need air returning and conducting. The device can also be used in children's drinking cups, but not limited thereto.

### BRIEF DESCRIPTION OF THE DRAWINGS

The following embodiments and the technical solutions are described in detail with the accompanying drawings. Brief descriptions of the figures are introduced as follows. Obviously, the accompanying drawings are only sonic specific embodiments of the present invention. People having ordinary skill in the art can obtain other figures according to the accompany figures without doing creative work.

FIG. 1 is a diagrammatic cross-section view of the nursing bottle having air returning function in one embodiment of the invention.

FIG. 2 is an assembly diagram of the air conduit, the one way valve and the mounting component in an embodiment of the nursing bottle having air returning flinch on.

FIG. 3 is a schematic view of the helm-like wheel in one embodiment of the invention, wherein the milk channel is a through hole.

FIG. 4 is a schematic view of the helm-like wheel in one embodiment of the invention, wherein the milk channel is a hole with a one-way valve.

FIG. 5 is a schematic view of the nipple in one embodiment of the invention, wherein the central bulge of the nipple is a milk hole.

FIG. 6 is a schematic view of the nipple in one embodiment of the invention, wherein the central bulge of the nipple is a nipple incision.

FIG. 7 is a connection diagram of another embodiment of the invention provided with gas hole, the supporting component, the air conduit and the elastic one-way valve, the mounting part, wherein the central bulge of the nipple is a milk hole.

FIG. 8 is a connection diagram of another embodiment of the invention provided with gas hole, the supporting component, the air conduit and the elastic one-way valve, the mounting part, wherein the central bulge of the nipple is a nipple incision.

The description of the labeled figure in the drawing:
1-nipple;
11-milk hole; 12-nipple incision; 13-supporting, component; 14-gas import hole:
2-fixing cover;
3-helm-like wheel;
31-air passage; 32-milk channel; 33-one-way valve;
4-air conduit;
41-first opening; 42-second opening; 43-back-up ring;
5-bottle body;
6-mounting part;
7-elastic one-way valve;
71-elastic one-way valve cut; 72-edges.

### DETAILED DESCRIPTION OF THE INVENTION

The embodiments of the invention are described below to get a better understanding for one skilled in the art, This disclosure is not limited to the embodiments; any variations of the invention in the scope of the claims and within the spirit of the invention are obvious, and within the scope of protection of the invention.

A nursing bottle having an air returning function, which comprises: bottle body 5, fixing cover 2, nipple 1, wherein one end of bottle body 5 opens and the other end of the bottle body 5 closes; fixing cover 2 is used to secure bottle body 5 and nipple 1.

The nursing bottle having an air returning function further comprises a ventilation component, wherein an inner ambiance of bottle body 5 exchanges air with an exterior circumstance through the ventilation component. In one preferred embodiment, helm-like wheel 3 or gas import hole 14 are used as the ventilation component. Helm-like wheel 3 or gas import hole 14 will be described below.

Air conduit 4 is a gas operated device with two ends opened. First opening 41 is connected to the ventilation component. In one preferred embodiment, air conduit 4 is a cylindrical pipe with two ends opened. The length of air conduit 4 should not be too long or too short, the length of air conduit 4 should correspond to bottle body 5. Preferably, the length of the air conduit 4 should be a bit less than the length of bottle body 5. Elastic one-way valve 7 is set at second opening 42 of air conduit 4 and located in the interior of air conduit 4, wherein elastic one-way valve 7 has at least one elastic one-way valve cut 71 thereon. The shape of elastic one-way valve cut 71 is not specifically restricted. The shape may comprise cross type, Y type, a horizontal shape or other types, and the shape is not limited thereto. The present invention does not restrict the specific shape of elastic one-way valve 7 only if elastic one-way valve 7 achieves the function of one direction conducting. The material of elastic one-way valve 7 is not specifically restricted. Materials like silicon rubber, natural rubber, synthetic rubber and plastic body or other suitable elastic material may be utilized. Mounting part 6 is located on second opening 42 of the air conduit 4 to fasten elastic one-way valve 7. In one preferred embodiment, mounting part 6 is located inside air conduit 4. Mounting part 6 and air conduit 4 are interference fit with each other. Unless damaged, elastic one-way valve 7 cannot be taken out from air conduit 4 even under exogenous forces. The ventilation component, the air conduit 4, elastic one-way valve7 and mounting part 6 forms a gas returning device and are located on the interior of bottle body 5.

In a preferred embodiment, the ventilation component is helm-like wheel 3. Helm-like wheel 3 is located on an opening of bottle body 5. Air passage 31 and milk channels 32 are located on helm-like wheel 3.

In a preferred embodiment, the ventilation component is helm-like wheel 3. Helm-like wheel 3 is located on an opening of bottle body 5. Air passage 31 and milk channels 32 are located on helm-like wheel 3. Air passage 31 is connected with first opening 41 of air conduit 4. The air in the inner ambiance of bottle body 5 passes through elastic one-way valve 7, air conduit 4 and air passage 31 to exchange with the exterior air of bottle body 5.

The milk in the inner ambiance flows into nipple 1 through milk channel 32.

Air passage 31 is connected to the first opening 41 of air conduit 4. The air in the inner ambiance passes through elastic one-way valve 7, air conduit 4 and air passage 31 to exchange air with the exterior of bottle body 5.

In one preferred embodiment, air passage 31 has an interference fit with first opening 41 of air conduit 4. This structure ensures a close contact between air passage 31 and the air conduit 4. Air passage 31 and air conduit 4 cannot separate from each other under natural conditions if there is no external force.

In one preferred embodiment, the diameter of the helm-like wheel is greater than or equal to the diameter of the opening of the bottle body 5, which guarantees that helm-like wheel 3 will not fall into the inner chamber of bottle body 5.

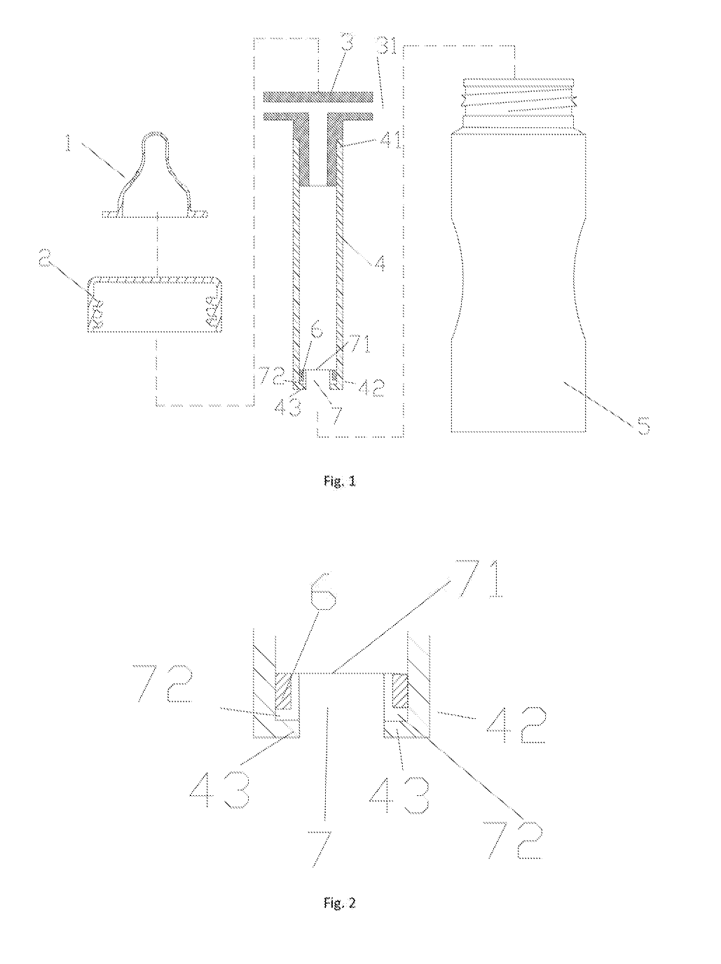

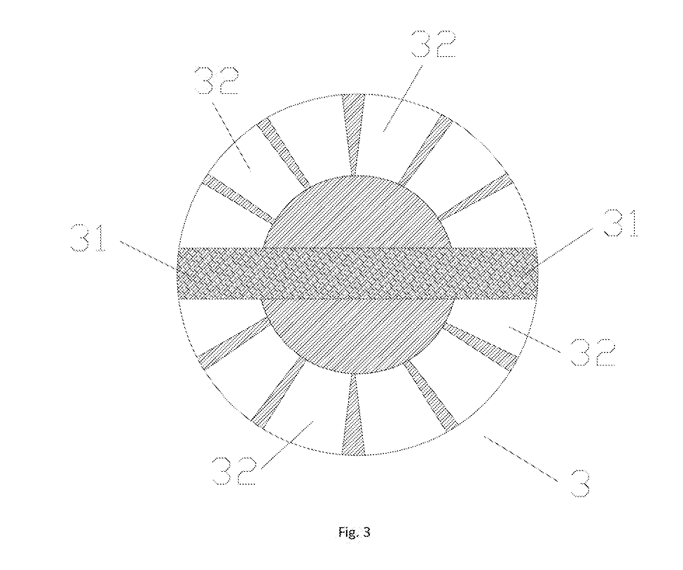

In one preferred embodiment, as is described in FIG. 2, one form of milk channel 32 can be described as follows: milk channel 32 is a through hole. The milk inside bottle body 5 flows into nipple 1 through the through hole. At the same time, referring to FIG. 3, another form of milk channel 32 is as follows: milk channel 32 is a hole with one-way valve, when there is an external force for sucking nipple 1, one-way valve 33 opens. Correspondingly, when nipple 1 is under normal condition, one-way valve 33 closes.

In one preferred embodiment, the ventilation component is gas import hole 14. Gas import. hole 14 is located at the side wall of nipple 1. The gas import hole 14 is connected with supporting component 13. Supporting component 13 is connected with first opening 41 of air conduit 4. The air in the inner ambiance passes through elastic one-way valve 7, air conduit 4, supporting component 13, gas import hole 14 and bottle body 5 in turn to exchange with the exterior air of bottle body 5.

In one preferred embodiment, supporting component 13 has an interference fit with first opening 41 of air conduit 4. That is, when there is no external force, supporting component 13 will not separate from air conduit 4. Supporting component 13 and air conduit 4 can be separated from each other under external force to clean supporting component 13 and air conduit 4 separately.

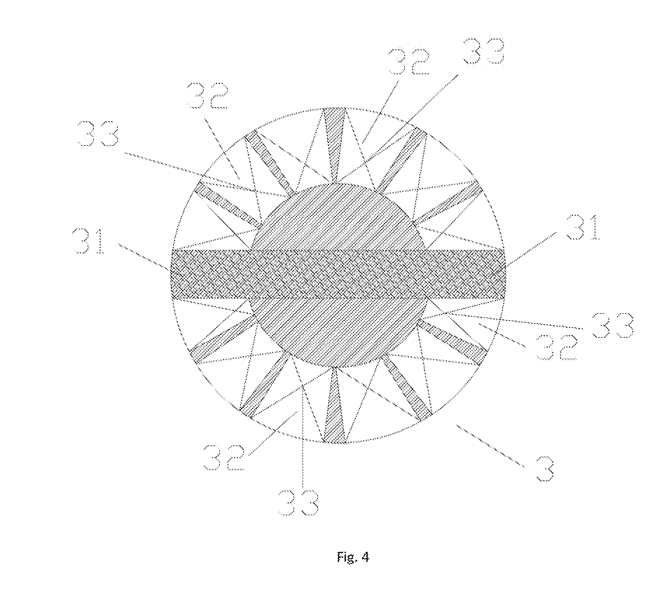

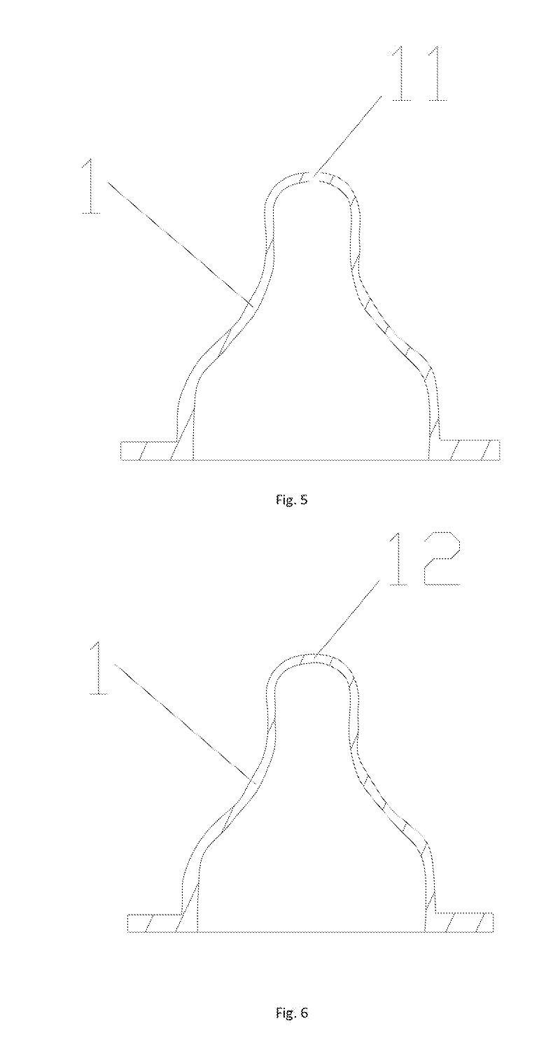

In one preferred embodiment, as shown in FIG. 4, one form of nipple 1 can be set as following: a milk hole is located at a central bulge of the mouth of nipple 1. Another form of nipple 1 can be set as following: a nipple incision is located on a central bulge of the mouth of nipple 1.

### The First Embodiment

Referring to FIG. 1, a nursing bottle having air returning function, comprising: bottle body 5, fixing cover 2, nipple 1, ventilation component, air conduit 4, elastic one-way valve 7 and mounting part 6, The ventilation component is helm-like wheel 3. The milk channel 32 set on helm-like wheel 3 is a through hole. The connecting way between air conduit 4, elastic one-way valve 7 and mounting part 6 is described as above. A milk hole 11 is located at a central bulge of the mouth of nipple 1.

First opening 41 of air conduit 4 is connected to air passage 31 of the helm-like wheel 3. The air in the inner ambiance passes through elastic one-way valve 7, air conduit 4 and air passage 31 to exchange with the exterior air of bottle body 5, forming an air returning passage between the inner ambiance and the exterior of the bottle. When the nipple 1 is under sucking condition, due to a pressure change, cut 71 on elastic one-way valve 7 slightly opens (cut 71 on elastic one-way valve 7 is in close condition when there is no external force applied on it). The inner pressure and the external pressure of bottle body 5 are almost the same. The milk inside bottle body 5 flows into nipple 1 through milk channel 31. Obviously, in this embodiment, milk inside bottle body 5 can only flow out when nipple 1 is being sucked. There'll be no air bubble generated in the milk, preventing the phenomenon of vomiting milk, choking and flatulence of the infant. At the same time, the number of nursing accessories are greatly reduced. The accessories of the present invention are easy to be taken apart and easy for installation, which brings in convenience for daily use, cleaning, sterilization and carrying. There are no tiny accessories, the swallowing of the baby can be avoided. The manufacturing process is relatively simple, and thus mass production can be easily achieved.

### The Second Embodiment

This embodiment differs from the first embodiment in that the central bulge of the mouth of nipple 1 mouth comprises nipple incision 12. When the bottle is inverted, the milk inside bottle body 5 will not flow through nipple 1. Only when the baby sucks nipple 1 and the cut on it opens, the milk inside the bottle body 5 flows out. All the rest components are the same as described in the first embodiment

### The Third Embodiment.

This embodiment differs from the first embodiment in that: milk channel 32 on helm-like wheel 3 is a hole with a cane-way valve. When the bottle is inverted, due to the one-way valve setting on milk channel 32, when there is no external force applied on the nipple 1, the one-way valve on milk channel 32 closes, and the milk inside bottle body 5 will not flow to nipple 1 or even to the external of bottle body 5 through milk channel 32. Only when the baby sucks the nipple 1, the one-way valve of milk channel 32 opens, then the milk flows out from the bottle body 5 through milk channel 32. All the rest components are the same as described in the first embodiment.

### The Fourth Embodiment

This embodiment differs from the first embodiment in that: the central bulge of the mouth of nipple 1 comprises nipple incision 12. Under the application of one-way valve 33 of milk channel 32, an additional anti-leakage component is set on nipple 1. When the bottle is inverted, the milk inside bottle body 5 will not flow to nipple 1. Only when the baby sucks nipple 1, cut 12 on nipple 1 opens, one-way valve 33 on the milk channel 32 opens, then the milk flows out from bottle body 5. All the rest components are the same as described in the third embodiment.

### The Fifth Embodiment

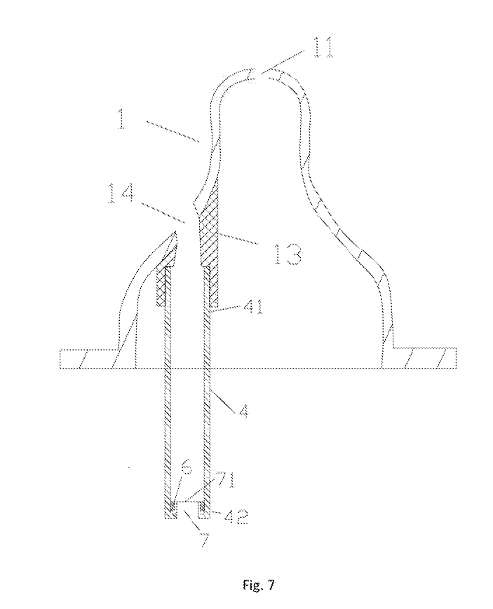

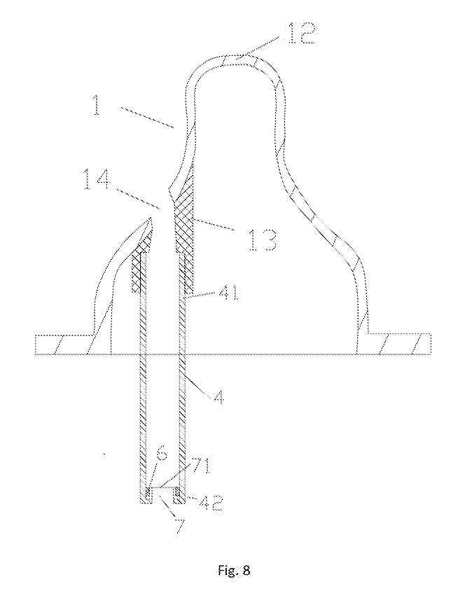

Referring to FIGS. 7-8, this embodiment differs from the first embodiment in that the ventilation component is gas import hole 14, supporting component 13 is connected with gas import hole 14. The connecting way of air conduit 4, elastic one-way valve 7 and mounting part 6 is as described above.

First opening 41 of air conduit 4 is connected to the supporting component 13. The air in the inner ambiance orderly passes through elastic one-way valve 7, air conduit 4, supporting component 13, gas import hole 14 and bottle body 5 to exchange with the exterior air of bottle body 5. An air returning passage is formed between the inner ambiance and the exterior of the bottle. The working principle in this embodiment is the same as the first embodiment.

### The Sixth Embodiment

Referring to FIG. 7, this embodiment differs from the fifth embodiment in that the central bulge of nipple 1 mouth comprises nipple incision 12. When the bottle is inverted, the milk inside bottle body 5 will not flow through nipple 1. Only when the baby sucks the nipple 1 and the nipple incision on it opens, the milk inside bottle body 5 flows out. All the rest components are the same as described in the fifth embodiment.

The first embodiment to the sixth embodiment can reduce the contacting area between the air and the milk, and this lowers the amount of loss of vitamin. The baby would not vomit milk due to sucking into air. The resistance for the flowing of the milk is reduced. The baby can suck milk without using too much strength. When the baby is not sucking, the milk inside the milk bottle is prevented from flowing out (decreasing the positive force to the lowest level when feeding). The milk flows out of the bottle only if the baby sucks the milk. The phenomenon of vomiting milk, choking and flatulence will be omitted since no air bubble is generated. The number of accessories for the bottle are greatly reduced, which brings in convenience for daily use, cleaning, sterilizing and carrying. The risk for the baby's swallowing of small accessories is reduced. The manufacturing process is relatively simple, the mass production is thus achieved. The air returning assembly of the present invention can be used in nursing bottles, but not limited thereto. It can also be used in other drinking containers which need the functions of air returning and conducting. The device can also be used in children's thinking cup, but not limited thereto.

While only several embodiments of the present invention have been shown and described, many changes and modifications may be made relative thereto without departing from the spirit and scope of the invention.

1. A nursing bottle having air returning function, comprising: a bottle body, a fixing cover, a nipple, wherein one end of the bottle body opens and another end of the bottle body closes; the fixing cover is used to fasten the bottle body and the nipple; characterized in that the nursing bottle further comprising:
a ventilation component, wherein an inner ambiance of the bottle body exchanges air with an exterior circumstances through the ventilation component;
an air conduit, wherein the air conduit is a has operated device with two ends of the air conduit opened a first opening is connected with the ventilation component;
an elastic one-way valve set at a second opening of the air conduit and located in the interior of the air conduit, wherein the elastic one-way valve has at least one cot thereon;
a mounting part located on the second opening of the air conduit to secure the elastic one-way valve; wherein the ventilation component, the air conduit, the elastic one-way valve and the mounting part form a gas returning device located in the interior of the bottle.

2. The nursing bottle having air returning function of claim 1, characterized in that: a back-up ring is located at the second opening of the air conduit; the back-up ring is used for the installation of the elastic one-way valve; the back-up ring and the air conduit form an integrated structure.

3. The nursing bottle having air returning function of claim 2, characterized in that: a plurality of corresponding edges of the back-up ring is located on the edges of the elastic one-way valve; wherein when the elastic one-way valve is connected to the air conduit, the plurality of corresponding edges are connected with the back-up ring.

4. The nursing bottle having air returning function of claim 3, characterized in that: the mounting part is installed on the plurality of corresponding edges to keep the elastic one-way valve at a nature status; wherein the mounting part is firmly connected with the air conduit.

5. The nursing bottle having air returning function of claim 1, characterized in that: the ventilation component is a helm-like wheel, which is located at an opening of the bottle body; an air passage and a milk channel are located on the helm-like wheel;
the air passage is connected to the first opening of the air conduit, the air in an inner ambiance passes through the elastic one-way valve, the air conduit and the air passage to exchange air with an exterior circumstance of the bottle body, the milk in the inner ambiance flows into the nipple through the milk channel.

6. The nursing bottle having air returning function of claim 5, characterized in that: the an passage has an interference fit with the first opening of the an conduit.

7. The nursing bottle having air returning function of claim 5, characterized in that: the milk channel is a through-hole, and the milk in the bottle body flows into the nipple through the through-hole.

8. The nursing bottle having air returning function of claim 5, characterized in that: the milk channel is a hole with a one-way valve, which is in open position when an external force is sucking on the nipple; the one-way valve is in a closed position when the nipple is in a normal status.

9. The nursing bottle having air returning function of claim 5, characterized in that: a diameter of the helm-like wheel is no less than a diameter of the opening of the bottle body.

10. The nursing bottle having air returning function of claim 1, characterized in that: the ventilation component is a gas import hole, which is located at a side wall of the nipple, a supporting component is connected to the gas import hole, the supporting component is used to support and connect the first opening of the gas import hole, the inner ambiance exchanges air with the exterior circumstance in a sequence through the elastic one-way valve, the air conduit, the supporting component and the gas import hole.

11. The nursing bottle having air returning function of claim 10, characterized in that: the supporting component has an interference fit with the first opening of the air conduit.

12. The nursing bottle baying air returning function of claim 1, characterized in that: a central bulge of a mouth of nipple is set with a milk hole.

13. The nursing bottle having air returning function of claim 1, characterized in that: the central bulge of the mouth of nipple comprises a nipple incision.
